(19) United States
(12) Patent Application Publication
(10) Pub. No.: US 2012/0164447 A1
(43) Pub. Date: Jun. 28, 2012

(54) Liquid Crystal Polyester Porous Film

(75) Inventor: Yusaku KOHINATA, Tsukuba-shi (JP)

(73) Assignee: SUMITOMO CHEMICAL COMPANY, LIMITED, Tokyo (JP)

(21) Appl. No.: 13/303,749

(22) Filed: Nov. 23, 2011

(30) Foreign Application Priority Data
Dec. 27, 2010 (JP) 2010-289603

(51) Int. Cl. D02G 3/00; C09K 19/38; C09K 19/54

(52) U.S. Cl. 428/364; 252/299.5

(57) ABSTRACT

An object of the present invention is to provide a porous membrane having excellent heat resistance and acid resistance. A porous membrane is constituted by a liquid crystal polyester and a polymer other than the liquid crystal polyester. A liquid crystal polyester having a reduced viscosity of 0.40 dL/g or more is used as the liquid crystal polyester. A polymer having a reduced viscosity of 0.40 dL/g or more is used as the polymer other than the liquid crystal polyester. The content of the polymer other than the liquid crystal polyester is adjusted from 10 to 40 parts by mass based on 100 parts by mass of the liquid crystal polyester.

### BACKGROUND OF THE INVENTION

(1) Field of the Invention

The present invention relates to a porous membrane obtained by using a liquid crystal polyester.

(2) Description of Related Art

A porous membrane of a polymer is used as a membrane filter in various fields such as water treatment field (e.g., production of drinking water, water treatment or waste water treatment), food industry field and medical field. For example, in the water treatment field, filtration of a polymer with a porous membrane has recently been carried out so as to remove impurities in water in place of conventional sand filtration and coagulative precipitation treatments. In the food industry field, a porous membrane of a polymer is used as a membrane filter for separation and removal of yeast used in fermentation, and concentration of a liquid. In the medical field, a porous membrane of a polymer is used as a membrane filter for artificial dialysis.

As described above, heat resistance is often required to the porous membrane of a polymer used as the membrane filter so as to be easily adaptable when a fluid to be filtered is heated so as to enhance penetration efficiency, or a porous membrane is subjected to a heat treatment for sterilization or drying. Therefore, there has been studied mainly, as the material of the porous membrane, a polysulfone which is a polymer having excellent heat resistance. For example, JP-A-2006-230459 describes that a polysulfone having a reduced viscosity of 0.15 to 0.6 dL/g is used as the material of a hollow fiber membrane.

### SUMMARY OF THE INVENTION

However, since the porous membrane of the polysulfone does not necessarily have sufficient acid resistance, it is unsuited for filtration of an acidic fluid, and use of an acid is limited at the time of washing. Thus, an object of the present invention is to provide a porous membrane having excellent heat resistance and acid resistance.

In order to achieve the object, the present invention provides a porous membrane comprising a liquid crystal polyester having a reduced viscosity of 0.40 dL/g or more and a polymer having a reduced viscosity of 0.40 dL/g or more other than the liquid crystal polyester, wherein the content of the polymer is from 10 to 40 parts by mass based on 100 parts by mass of the liquid crystal polyester.

The porous membrane of the present invention has excellent heat resistance and acid resistance.

### DETAILED DESCRIPTION OF PREFERRED EMBODIMENTS

The porous membrane of the present invention includes a liquid crystal polyester and a polymer other than the liquid crystal polyester. Inclusion of the liquid crystal polyester leads to a porous membrane having excellent heat resistance. Inclusion of the polymer other than the liquid crystal polyester facilitates formation of pores of the porous membrane, and facilitates formation of hollow when a hollow fiber membrane is obtained as the porous membrane.

The liquid crystal polyester is a liquid crystal polyester which exhibits mesomorphism in a molten state and is preferably melted at a temperature of 450° C. or lower. The liquid crystal polyester may be a liquid crystal polyester amide, a liquid crystal polyester ether, a liquid crystal polyester carbonate, or a liquid crystal polyester imide. The liquid crystal polyester is preferably a wholly aromatic liquid crystal polyester obtained by using only an aromatic compound as a raw monomer.

Typical examples of the liquid crystal polyester include those obtained by polymerization (polycondensation) an aromatic hydroxycarboxylic acid, an aromatic dicarboxylic acid, and at least one kind of compound selected from the group consisting of an aromatic diol, an aromatic hydroxyamine and an aromatic diamine; those obtained by polymerization of plural kinds of aromatic hydroxycarboxylic acids; those obtained by polymerization of an aromatic dicarboxylic acid, and at least one kind of compound selected from the group consisting of an aromatic diol, an aromatic hydroxyamine and an aromatic diamine; and those obtained by polymerization of a polyester such as polyethylene terephthalate, and an aromatic hydroxycarboxylic acid. Herein, there may be used a polymerizable derivative thereof in place of a part or all of the aromatic hydroxycarboxylic acid, aromatic dicarboxylic acid, aromatic diol, aromatic hydroxyamine and aromatic diamine, each independently.

Examples of the polymerizable derivative of the compound having a carboxyl group such as an aromatic hydroxycarboxylic acid or aromatic dicarboxylic acid include those obtained by converting a carboxyl group into an alkoxycarbonyl group or an aryloxycarbonyl group (ester); those obtained by converting a carboxyl group into a haloformyl group (acid halide); and those obtained by converting a carboxyl group into an acyloxycarbonyl group (acid anhydride). Examples of the polymerizable derivative of the compound having a hydroxyl group such as an aromatic hydroxycarboxylic acid, an aromatic diol or an aromatic hydroxylamine include those obtained by converting a hydroxyl group into an acyloxyl group through acylation (acylated product). Examples of the polymerizable derivative of the compound having an amino group such as an aromatic hydroxyamine or an aromatic diamine include those obtained by converting an amino group into an acylamino group through acylation (acylated product).

The liquid crystal polyester preferably includes a repeating unit represented by the following formula (1) (hereinafter may be sometimes referred to as a “repeating unit (1)”), and more preferably includes the repeating unit (1), a repeating unit represented by the following formula (2) (hereinafter may be sometimes referred to as a “repeating unit (2)”) and a repeating unit represented by the following formula (3) (hereinafter may be sometimes referred to as a “repeating unit (3))”:

—O—Ar¹—CO—, (1)

—CO—Ar²—CO—, and (2)

—X—Ar³—Y— (3)

wherein Ar¹ represents a phenylene group, a naphthylene group or a biphenylylene group; Ar² and Ar³ each independently represents a phenylene group, a naphthylene group, a biphenylylene group or a group represented by the following formula (4); X and Y each independently represents an oxygen atom or an imino group (—NH—); and hydrogen atoms existing in the group represented by Ar¹, Ar² or Ar³ each independently may be substituted with a halogen atom, an alkyl group or an aryl group, and

—Ar⁴—Z—Ar⁵— (4)

wherein Ar⁴ and Ar⁵ each independently represents a phenylene group or a naphthylene group; and Z represents an oxygen atom, a sulfur atom, a carbonyl group, a sulfonyl group or an alkylidene group.

Examples of the halogen atom include a fluorine atom, a chlorine atom, a bromine atom and an iodine atom. Examples of the alkyl group include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group and an n-decyl group, and the number of carbon atoms is usually from 1 to 10. Examples of the aryl group include a phenyl group, an o-tolyl group, an m-tolyl group, a p-tolyl group, a 1-naphthyl group and a 2-naphthyl group, and the number of carbon atoms is usually from 6 to 20. When the hydrogen atom is substituted with these groups, the number thereof is independently usually 2 or less, and preferably 1 or less, respectively, every group represented by Ar¹, Ar² or Ar³.

Examples of the alkylidene group include a methylene group, an ethylidene group, an isopropylidene group, an n-butylidene group and a 2-ethylhexylidene group, and the number of carbon atoms is usually from 1 to 10.

The repeating unit (1) is a repeating unit derived from a predetermined aromatic hydroxycarboxylic acid. The repeating unit (1) is preferably a repeating unit in which Ar¹ is a p-phenylene group (repeating unit derived from a p-hydroxybenzoic acid), or a repeating unit in which Ar¹ is a 2,6-naphthylene group (repeating unit derived from 6-hydroxy-2-naphthoic acid).

The repeating unit (2) is a repeating unit derived from a predetermined aromatic dicarboxylic acid. The repeating unit (2) is preferably a repeating unit in which Ar² is a p-phenylene group (repeating unit derived from terephthalic acid), a repeating unit in which Ar² is a m-phenylene group (repeating unit derived from isophthalic acid), a repeating unit in which Ar² is a 2,6-naphthylene group (repeating unit derived from 2,6-naphthalenedicarboxylic acid), or a repeating unit in which Ar² is a diphenylether-4,4′-diyl group (repeating unit derived from diphenylether-4,4′-dicarboxylic acid).

The repeating unit (3) is a repeating unit derived from a predetermined aromatic diol, an aromatic hydroxylamine or an aromatic diamine. The repeating unit (3) is preferably a repeating unit in which Ar³ is a p-phenylene group (repeating unit derived from hydroquinone, p-aminophenol or p-phenylenediamine), or a repeating unit in which Ar³ is a 4,4′-biphenylylene group (repeating unit derived from 4,4′-dihydroxybiphenyl, 4-amino-4′-hydroxybiphenyl or 4,4′-diaminobiphenyl).

The content of the repeating unit (1) is usually 30 mol % or more, preferably 30 to 80 mol %, more preferably from 35 to 65 mol %, and still more preferably from 40 to 55 mol %, based on the total amount of all repeating units (value in which the mass of each repeating unit constituting a liquid crystal polyester is divided by a formula weight of each repeating unit thereof to determine the amount (mol) corresponding to the amount of a substance of each repeating unit, and then the obtained amounts are totaled). The content of the repeating unit (2) is usually 35 mol % or less, preferably from 10 to 35 mol %, more preferably from 17.5 to 32.5 mol %, and still more preferably from 22.5 to 30 mol %, based on the total amount of all repeating units. The content of the repeating unit (3) is usually 35 mol % or less, preferably from 10 to 35 mol %, more preferably from 17.5 to 32.5 mol %, and still more preferably from 22.5 to 30 mol %, based on the total amount of all repeating units. As the content of the repeating unit (1) increases, heat resistance as well as strength and rigidity of the porous membrane are likely to be improved. However, when the content is too large, solubility of the liquid crystal polyester in a solvent is likely to decrease and thus it becomes difficult to apply to the production of a porous membrane using the below-mentioned solution.

A ratio of the content of the repeating unit (2) to the content of the repeating unit (3) is usually from 0.9/1 to 1/0.9, preferably from 0.95/1 to 1/0.95, and more preferably from 0.98/1 to 1/0.98, in terms of [content of the repeating unit (2)]/[content of the repeating unit (3)] (mol/mol).

The liquid crystal polyester may include two or more kinds of each of the repeating units (1) to (3), independently. The liquid crystal polyester may include a repeating unit other than the repeating units (1) to (3), and the content thereof is usually 10 mol % or less, and preferably 5 mol % or less, based on the total amount of all repeating units.

The liquid crystal polyester preferably includes, as the repeating unit (3), a repeating unit in which X and/or Y is/are imino group(s), that is, a repeating unit derived from a predetermined aromatic hydroxylamine and/or a repeating unit derived from an aromatic diamine, because of excellent solubility in a solvent, and more preferably includes, as the repeating unit (3), only a repeating unit in which X and/or Y is/are imino group(s).

The liquid crystal polyester is preferably produced by melt-polymerizing a raw monomer corresponding to a repeating unit constituting the liquid crystal polyester, and subjecting the obtained polymer (prepolymer) to solid phase polymerization. Whereby, it is possible to produce a high-molecular weight liquid crystal polyester having excellent heat resistance as well as high strength and rigidity with satisfactory operability. The melt polymerization may be carried out in the presence of a catalyst, and examples of the catalyst include metal compounds such as magnesium acetate, stannous acetate, tetrabutyl titanate, lead acetate, sodium acetate, potassium acetate and antimony trioxide; and nitrogen-containing heterocylic compounds such as 4-(dimethylamino)pyridine and 1-methylimidazol. Among these catalysts, nitrogen-containing heterocylic compounds are preferably used.

The liquid crystal polyester usually has a flow temperature of 250° C. or higher, preferably 250° C. to 350° C., and more preferably 260° C. to 330° C. As the flow temperature becomes higher, heat resistance as well as strength and rigidity are likely to be improved. However, the flow temperature is too high, solubility in a solvent is likely to decrease, and the viscosity of the solution is likely to increase.

The flow temperature means a temperature at which a melt viscosity becomes 4,800 Pa·s (48,000 poise) when a liquid crystal polyester is melted while heating at a heating rate of 4° C./min under a load of 9.8 MPa (100 kg/cm²) and extruded through a nozzle having an inner diameter of 1 mm and a length of 10 mm using a capillary rheometer, and the flow temperature serves as an index indicating a molecular weight of the liquid crystal polyester (see “Liquid Crystalline Polymer—Synthesis, Molding, and Application” edited by Naoyuki Koide, page 95, CMC Publishing CO., LTD., issued on Jun. 5, 1987).

In the present invention, a liquid crystal polyester having a reduced viscosity of 0.40 dL/g or more is used as the liquid crystal polyester. Whereby, formation of pores of the porous membrane is facilitated and formation of hollow is facilitated when a hollow fiber membrane is obtained as the porous membrane. Also, strength and rigidity of the porous membrane are improved. The reduced viscosity of the liquid crystal polyester is preferably 0.45 dL/g or more, and more preferably 0.50 dL/g or more. Similar to the flow temperature, the reduced viscosity of the liquid crystal polyester serves as an index indicating a molecular weight. When the reduced viscosity is too high, solubility in a solvent is likely to decrease, and the viscosity of the solution is likely to increase. Therefore, the reduced viscosity is usually 0.80 dL/g or less, and preferably 0.70 dL/g or less.

The reduced viscosity of the liquid crystal polyester can be increased by increasing the polymerization temperature or extending the polymerization time in case of producing the liquid crystal polyester.

Examples of the polymer other than the liquid crystal polyester include water-insoluble polymers such as polysulfone, polyacrylonitrile, polyester, polyamide, polystyrene and polymethyl methacrylate, and two or more kinds of these polymers may be optionally used. Among these polymers, polysulfone is preferable since it is likely to give a porous membrane having excellent heat resistance as well as strength and rigidity.

The polysulfone is typically a polymer including a repeating unit which has a divalent aromatic group (residue in which two hydrogen atoms linked to an aromatic ring of an aromatic compound are removed from the aromatic compound), a sulfonyl group (—SO₂—) and an oxygen atom. From the viewpoint of heat resistance and chemical resistance, the polysulfone preferably includes a repeating unit represented by the following formula (A) (hereinafter may be sometimes referred to as a “repeating unit (A)”), and further includes one or more kinds of other repeating units such as a repeating unit represented by the following formula (B) (hereinafter may be sometimes referred to as a “repeating unit (B)”) and a repeating unit represented by the following formula (C) (hereinafter may be sometimes referred to as a “repeating unit (C)”):

-Ph¹-SO₂-Ph²-O— (A)

wherein Ph¹ and Ph² each independently represents a phenylene group, and hydrogen atoms existing in the phenylene group each independently may be substituted with an alkyl group, an aryl group or a halogen atom,

Ph³-R-Ph⁴-O— (B)

wherein Ph³ and Ph⁴ each independently represents a phenylene group, hydrogen atoms existing in the phenylene group each independently may be substituted with an alkyl group, an aryl group or a halogen atom, and R represents an alkylidene group, an oxygen atom or a sulfur atom, and

-(Ph⁵)ₙ-O— (C)

wherein Ph⁵ represents a phenylene group, hydrogen atoms existing in the phenylene group each independently may be substituted with an alkyl group, an aryl group or a halogen atom, n represents an integer of from 1 to 3 and, when n is 2 or more, existing plural Ph⁵(s) may be the same or different with each other.

The phenylene group represented by any one of Ph¹ to Ph⁵ may be a p-phenylene group, an m-phenylene group or an o-phenylene group, and is preferably a p-phenylene group. Examples of the alkyl group, with which the hydrogen atom existing in the phenylene group may be substituted, include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group and an n-decyl group, and the number of carbon atoms is usually from 1 to 10. Examples of the aryl group, with which the hydrogen atom existing in the phenylene group may be substituted, include a phenyl group, an o-tolyl group, an m-tolyl group, a p-tolyl group, a 1-naphthyl group and a 2-naphthyl group, and the number of carbon atoms is usually from 6 to 20. When the hydrogen atom existing in the phenylene group is substituted with these groups, the number thereof is independently usually 2 or less, and preferably 1 or less every phenylene group.

Examples of the alkylidene group as for R include a methylene group, an ethylidene group, an isopropylidene group and a 1-butylidene group, and the number of carbon atoms is usually from 1 to 5.

The polysulfone preferably includes a repeating unit (A) in the proportion of 50 mol % or more, more preferably 80 mol % or more, based on the total amount of all repeating units, and still more preferably includes, as the repeating unit, only a repeating unit (A), substantially. The polysulfone may include two or more kinds of each of repeating units (A) to (C), independently.

The polysulfone can be produced by polymerization (polycondensation) of a dihalogenosulfone compound corresponding to the repeating unit constituting the polysulfone, and a dihydroxy compound. For example, the polysulfone including a repeating unit (A) can be produced by using, as a dihalogenosulfone compound, a compound represented by the following formula (D) (hereinafter may be sometimes referred to as a “compound (D)”) and using, as the dihydroxy compound, a compound represented by the following formula (E) (hereinafter may be sometimes referred to as a “compound (E)”). The polysulfone including a repeating unit (A) and a repeating unit (B) can be produced by using, as the dihalogenosulfone compound, a compound (D) and using, as the dihydroxy compound, a compound represented by the following formula (F) (hereinafter may be sometimes referred to as a “compound (F)”). The polysulfone including a repeating unit (A) and a repeating unit (C) can be produced by using, as the dihalogenosulfone compound, a compound (D) and using, as the dihydroxy compound, a compound represented by the following formula (G) (hereinafter may be sometimes referred to as a “compound (G)”).

X¹-Ph¹-SO₂-Ph²-X² (D)

wherein X¹ and X² each independently represents a halogen atom, and Ph¹ and Ph² have the same meanings as defined above.

HO-Ph¹-SO₂-Ph²-HO (E)

wherein Ph¹ and Ph² have the same meanings as defined above.

HO-Ph³-R-Ph⁴-OH (F)

wherein Ph³, Ph⁴ and R have the same meaning as defined above.

HO-(Ph⁵)ₙ-OH (G)

wherein Ph⁵ and n have the same meanings as defined above.

The polymerization is preferably carried out in a solvent using an alkali metal salt of carbonic acid. The alkali metal salt of carbonic acid may be an alkali carbonate which is a normal salt, an alkali bicarbonate (alkali hydrogen carbonate) which is an acid salt, or a mixture of both salts. Sodium carbonate or potassium carbonate is preferably used as the alkali carbonate, and sodium bicarbonate or potassium bicarbonate is preferably used as the alkali bicarbonate. Organic polar solvents such as dimethyl sulfoxide, 1-methyl-2-pyrrolidone, sulfolane (1,1-dioxathiolane), 1,3-dimethyl-2-imidazolidinone, 1,3-diethyl-2-imidazolidinone, dimethylsulfone, diethylsulfone, diisopropylsulfone and diphenylsulfone are preferably used as the solvent.

In the present invention, a polymer having a reduced viscosity of 0.40 dL/g or more is used as the polymer other than the liquid crystal polyester. Whereby, formation of pores of the porous membrane is facilitated and formation of hollow thereof is facilitated when a hollow fiber membrane is obtained as the porous membrane. Also, strength and rigidity of the porous membrane are improved. The reduced viscosity of the polymer is preferably 0.45 dL/g or more, and more preferably from 0.50 dL/g or more. The reduced viscosity of the polymer serves as an index indicating a molecular weight. When the reduced viscosity is too high, solubility in a solvent is likely to decrease, and the viscosity of the solution is likely to increase. Therefore, the reduced viscosity is usually 0.80 dL/g or less, and preferably 0.70 dL/g or less.

The reduced viscosity of the polymer other than the liquid crystal polyester can be increased by adjusting the conditions of polymerization temperature, polymerization time and the like in case of producing the polymer. For example, in case of the polysulfone, if no side reaction occurs in the polymerization, the polymerization degree of the obtained polysulfone is likely to increase and the reduced viscosity is likely to increase as a molar ratio of a dihalogenosulfone compound to a dihydroxy compound becomes closer to 1:1 and the use amount of an alkali metal salt of carbonic acid increases, and also the polymerization temperature becomes higher and the polymerization time becomes longer. However, actually, by-produced alkali hydroxide causes the reaction of conversion of a halogeno group into a hydroxyl group and the side reaction such as depolymerization, and the side reaction is likely to cause a decrease in polymerization degree of the obtained polysulfone and a decrease in reduced viscosity. Therefore, it is preferred to adjust the molar ratio of the dihalogenosulfone compound to the dihydroxy compound, use amount of an alkali metal salt of carbonic acid, polycondensation temperature and polycondensation time so as to obtain a polysulfone having a desired reduced viscosity, taking the degree of the side reaction into consideration.

The content of the polymer in the porous membrane is from 10 to 40 parts by mass, preferably from 10 to 30 parts by mass, and more preferably from 15 to 25 parts by mass, based on 100 parts by mass of the liquid crystal polyester. When the content of the polymer is too small, formation of pores of the porous membrane becomes insufficient and formation of hollow becomes insufficient when hollow fiber membrane is obtained as the porous membrane. Although depending on the kind, when the content of the polymer is too large, heat resistance and acid resistance of the porous membrane become insufficient.

The porous membrane may be, for example, a flat membrane, a tubular membrane, a hollow fiber membrane, a single-layered membrane, or a multi-layered membrane. In case of the multi-layered membrane, the membrane may be a multi-layered membrane including two or more of only the layers each containing the liquid crystal polyester and the polymer, or a multi-layered membrane including one or more layers containing the liquid crystal polyester and the polymer and also including one or more other layers.

In the production of the porous membrane, a known method can be appropriately employed. For example, the porous membrane may be produced by dissolving the liquid crystal polyester and the polymer in a solvent, extruding the obtained solution into a predetermined shape, and introducing the extrudate into a coagulating liquid using a dry wet method through an air gap or a wet method without an air gap, followed by phase separation and further desolvation, or produced by dissolving the liquid crystal polyester and the polymer in a solvent, flow casting the obtained solution on a base material having a predetermined shape, and immersing the base material in a coagulating liquid, followed by phase separation and further desolvation.

When a hollow fiber membrane is produced as the porous membrane, the porous membrane is preferably produced by using the solution as a spinning dope, ejecting the solution from the sheath side using a core-sheath type double tubular nozzle, and ejecting a coagulating liquid (hereinafter may be sometimes referred to as an “internal coagulating liquid”) or a gas from the core side, followed by introducing them into a coagulating liquid (hereinafter may be sometimes referred to as an “external coagulating liquid”) through an air gap or without an air gap.

Examples of the good solvent of the liquid crystal polyester and the polymer used in the preparation of the solution (hereinafter may be sometimes referred simply to as a “good solvent”) include N-methylpyrrolidone, N,N-dimethylformamide, N,N-dimethylacetamide and dimethyl sulfoxide. The solution may contain components other than the liquid crystal polyester, polymer and good solvent, for example, a hydrophilic polymer, a poor solvent of the liquid crystal polyester and the polymer (hereinafter may be sometimes referred simply to as a “poor solvent”) and a swelling agent. It is possible to obtain a porous membrane, which has excellent water permeability and is suitably used in filtrations such as ultrafiltration of an aqueous fluid, and precise filtration by allowing the solution to contain a hydrophilic polymer.

Examples of the hydrophilic polymer include polyvinyl pyrrolidone; polyalkylene glycol such as polyethylene glycol or polypropylene glycol; polyvinyl alcohol; polyhydroxyalkyl (meth)acrylate such as polyhydroxyethyl acrylate or polyhydroxyethyl methacrylate; polyacrylamide; and polyethyleneimine. Optionally, two or more kinds of these polymers may be used. It is preferable to use polyvinyl pyrrolidone, especially high-molecular weight polyvinyl pyrrolidone having a molecular weight of 1,000,000 to 3,000,000 since it is possible to enhance the thickening effect of the solution even in case of small content.

Water is usually used as the poor solvent.

Examples of the swelling agent include ethylene glycols such as ethylene glycol, diethylene glycol and triethylene glycol. Among these, ethylene glycol is preferable since it is easy to remove.

It is possible to use, as the coagulating liquid, a poor solvent, and a mixed solvent of a poor solvent and a good solvent. It is preferable that, when a mixed solvent of a poor solvent and a good solvent is used as the coagulating liquid, the pore diameter and pore size distribution of the obtained porous membrane can be adjusted by adjusting a mixing ratio of a mixed solvent of the poor solvent to the good solvent. In case of producing a hollow fiber membrane as the porous membrane, when a mixed solvent of a poor solvent and a good solvent is used together with an internal coagulating liquid and an external coagulating liquid, these effects can be efficiently extracted. The subsequent recovery of the solvent can also be easily carried out by using this mixed solvent.

Examples of the present invention will be described below, but the present invention is not limited thereto.

### (Measurement of Reduced Viscosity)

A sample (about 1 g) was dissolved in N-methyl pyrrolidone to adjust the volume to 1 dL, and the viscosity (η) of the obtained solution was measured at 25° C. using an Ostwald viscometer. The viscosity (η₀) of N-methyl pyrrolidone as a solvent was measured at 25° C. using an Ostwald viscometer. A specific viscosity ((η-η₀)/η) was determined from the viscosity (η) of the solution and the viscosity (η₀) of the solvent, and then the obtained specific viscosity was divided by the concentration (about 1 g/dL) of the solution to determine the reduced viscosity (dL/g).

### (Evaluation of Acid Resistance)

A hollow fiber membrane was subjected to an acid treatment by immersing in an aqueous 50 mass % sulfuric acid solution at 80° C. for 5 hours and washed with water, followed by drying. Each reduced viscosity of the hollow fiber membrane before and after the acid treatment was measured and then a decrease rate of the reduced viscosity was determined by the following equation.

Decrease rate (%) of reduced viscosity=([reduced viscosity before acid treatment]−[reduced viscosity after acid treatment])/[reduced viscosity before acid treatment)×100

### Production Example 1

### Production of Liquid Crystal Polyester (1)

In a reactor equipped with a stirrer, a torque meter, a nitrogen gas introducing tube, a thermometer and a reflux condenser, 941 g (5.0 mol) of 6-hydroxy-2-naphthoic acid, 415.3 g (2.5 mol) of isophthalic acid, 273 g (2.5 mol) of 4-aminophenol and 1,123 g (11 mol) of acetic anhydride were charged. After replacing a gas in the reactor by a nitrogen gas, the temperature was raised from room temperature to 150° C. over 15 minutes while stirring under a nitrogen gas flow and the mixture was refluxed at 150° C. for 3 hours. While distilling off by-produced acetic acid and the unreacted acetic anhydride, the temperature was raised from 150° C. to 320° C. over 2 hours and 50 minutes, followed by maintaining at 320° C. At the point of time when an increase in torque was recognized, contents were taken out from the reactor and then cooled to room temperature. The obtained solid was crushed by a crusher, subjected to solid phase polymerization by maintaining at 250° C. for 10 hours under a nitrogen gas atmosphere and then cooled to room temperature to obtain a powdered liquid crystal polyester (1). The obtained liquid crystal polyester (1) showed a reduced viscosity of 0.51 g/dL.

### Production Example 2

### Production of Liquid Crystal Polyester (2)

In the same operation as in Production Example 1, except that the temperature of the solid phase polymerization was changed from 250° C. to 240° C., a powdered liquid crystal polyester (2) was obtained. The obtained liquid crystal polyester (2) showed a reduced viscosity of 0.34 g/dL.

### Production Example 3

### Production of Polysulfone (1)

In a reactor equipped with a stirrer, a nitrogen gas introducing tube, a thermometer and a reflux condenser, 589 g of bis(4-chlorophenyl)sulfone, 500 g of bis(4-hydroxyphenyl)sulfone and 942 g of diphenylsulfone (solvent) were charged, and the temperature was raised from room temperature to 180° C. while stirring under a nitrogen gas flow. Then, 287 g of potassium carbonate was added. While distilled off by-produced water, the temperature was gradually raised from 180° C. to 290° C. After maintaining at 290° C. for 2 hours, contents were taken out from the reactor and then cooled to room temperature. The obtained solid was crushed by a crusher, washed with warm water and washed with a mixed solvent of acetone and methanol several times, and then dried with heating at 150° C. to obtain a chloro group-terminated powdered polysulfone (1). The obtained polysulfone (1) showed a reduced viscosity of 0.52 dL/g.

### Production Example 4

### Production of Polysulfone (2)

In the same operation as in Production Example 3, except that the use amount of bis(4-chlorophenyl)sulfone was changed from 589 g to 598 g and the use amount of diphenylsulfone (solvent) was changed from 942 g to 957 g, a chloro group-terminated powdered polysulfone (2) was obtained. The obtained polysulfone (2) showed a reduced viscosity of 0.36 dL/g.

### Example 1 and Comparative Examples 1 to 4

The liquid crystal polyester (1) or (2), the polysulfone (1) or (2) and N-methylpyrrolidone (solvent) were mixed in the ratio shown in Table 1 to obtain a solution. The obtained solution was used as a spinning dope, ejected from the sheath side of a double tubular nozzle and then ejected from the core side of the double tubular nozzle using a mixed solvent of water and N-methyl pyrrolidone in a mass ratio of 70/30 as an internal coagulating liquid.

The ejected product was once passed through an air (5 mm) and then coagulated by introducing into a mixed solvent of water and N-methylpyrrolidone in a weight ratio of 70/30 as an external coagulating liquid maintained at 25° C. The obtained spun product was wound around a bobbin, and then washed in warm water at 80° C. for 3 hours under running water to remove the solvent. In Comparative Examples 1 to 3, no hollow was formed in the spun product and thus a hollow fiber membrane could not be obtained. With respect to the hollow fiber membranes obtained in Example 1 and Comparative Example 4, acid resistance was evaluated. The results are shown in Table 1.

TABLE 1

| | | | Examples | | | | |
|---|---|---|---|---|---|---|---|
| | | | | Comparative | Comparative | Comparative | Comparative |
| | | | Example 1 | Example 1 | Example 2 | Example 3 | Example 4 |
| Liquid crystal | | Parts by | 100 | — | 100 | 100 | 100 |
| polyester | | mass | | | | | |
| (1) | | | | | | | |
| Liquid crystal | | Parts by | — | 100 | — | — | — |
| polyester | | mass | | | | | |
| (2) | | | | | | | |
| Polysulfone | | Parts by | 18 | 20 | — | 9 | 100 |
| (1) | | mass | | | | | |
| Polysulfone | | Parts by | — | — | 18 | — | — |
| (2) | | mass | | | | | |
| N-methyl | | Parts by | 471 | 280 | 471 | 479 | 800 |
| pyrrolidone | | mass | | | | | |
| Reduced | Before | (dL/g) | 0.51 | — | — | — | 0.51 |
| viscosity | acid | | | | | | |
| | treatment | | | | | | |
| | After | (dL/g) | 0.49 | — | — | — | 0.41 |
| | acid | | | | | | |
| | treatment | | | | | | |
| | Decrease | (%) | 3.9 | — | — | — | 19.6 |
| | rate | | | | | | |

What is claimed is:

1. A porous membrane comprising a liquid crystal polyester having a reduced viscosity of 0.40 dL/g or more and a polymer having a reduced viscosity of 0.40 dL/g or more other than the liquid crystal polyester, wherein the content of the polymer is from 10 to 40 parts by mass based on 100 parts by mass of the liquid crystal polyester.

2. The porous membrane according to claim 1, wherein the liquid crystal polyester is a liquid crystal polyester including a repeating unit represented by the following formula (1), a repeating unit represented by the following formula (2) and a repeating unit represented by the following formula (3):
—O—Ar¹—CO—, (1)
—CO—Ar²—CO—, and (2)
—X—Ar³—Y— (3)
wherein Ar¹ represents a phenylene group, a naphthylene group or a biphenylylene group; Ar² and Ar³ each independently represents a phenylene group, a naphthylene group, a biphenylylene group or a group represented by the following formula (4); X and Y each independently represents an oxygen atom or an imino group; and hydrogen atoms existing in the group represented by Ar¹, Ar² or Ar³ each independently may be substituted with a halogen atom, an alkyl group or an aryl group, and
—Ar⁴—Z—Ar⁵— (4)
wherein Ar⁴ and Ar⁵ each independently represents a phenylene group or a naphthylene group; and Z represents an oxygen atom, a sulfur atom, a carbonyl group, a sulfonyl group or an alkylidene group.

3. The porous membrane according to claim 1, wherein the polymer is polysulfone.

4. The porous membrane according to claim 3, wherein the polysulfone is a polysulfone including a repeating unit represented by the following formula (A):
-Ph¹-SO₂-Ph²-O— (A)
wherein Ph¹ and Ph² each independently represents a phenylene group, and hydrogen atoms existing in the phenylene group each independently may be substituted with an alkyl group, an aryl group or a halogen atom.

5. The porous membrane according to claim 1, which is a hollow fiber membrane.
